(19) United States
(12) Patent Application Publication
(10) Pub. No.: US 2024/0326042 A1
(43) Pub. Date: Oct. 3, 2024

(54) Flow Cells and Related Flow Cell Manifold Assemblies and Methods

(71) Applicant: ILLUMINA, INC., San Diego, CA (US)

(72) Inventors: Bradley Drews, Poway, CA (US); Darren Segale, San Diego, CA (US); Jennifer Foley, San Diego, CA (US); Jack Twomey, San Diego, CA (US)

(21) Appl. No.: 18/572,786

(22) PCT Filed: Sep. 29, 2022
(86) PCT No.: PCT/US22/45141

§ 371 Date: Dec. 21, 2023

Related U.S. Application Data
(60) Provisional application No. 63/250,961, filed on Sep. 30, 2021.

(51) Int. Cl. B01L 3/00; G01N 15/1434

(52) U.S. Cl. CPC B01L 3/502715; G01N 15/1436; B01L 2200/026; B01L 2200/0689; B01L 2300/0887

(57) ABSTRACT

Flow cell manifold assemblies and methods are disclosed. In an implementation, an apparatus includes a flow cell and a flow cell manifold. The flow cell has a channel. The flow cell defines a plurality of first openings fluidically coupled to the channel and arranged on a first side of the channel and a plurality of second openings fluidically coupled the channel and arranged on a second side of the channel. The flow cell manifold assembly is coupled to the flow cell and has a first manifold fluidic line having a first fluidic line opening and being fluidically coupled to each of the first openings and has a second manifold fluidic line having a second fluidic line opening and being fluidically coupled to each of the second openings.

### RELATED APPLICATION SECTION

This application claims the benefit of and priority to U.S. Provisional Patent Application No. 63/250,961, filed Sep. 30, 2021, the content of which is incorporated by reference herein in its entirety and for all purposes.

### BACKGROUND

Sequencing platforms may include fluidic interfaces that can form a fluidic connection with a flow cell and enable fluid to be flowed through a channel of the flow cell.

### SUMMARY

Advantages of the prior art can be overcome and benefits as described later in this disclosure can be achieved through the provision of flow cells and related flow cell manifold assemblies and methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus includes a system and a flow cell assembly. The system includes a flow cell interface and the flow cell assembly includes a flow cell, a flow cell manifold assembly, and one or more gaskets. The flow cell has a channel and the flow cell defines a plurality of first openings fluidically coupled to the channel and arranged on a first side of the channel and a plurality of second openings fluidically coupled to the channel and arranged on a second side of the channel. The flow cell manifold assembly is coupled to the flow cell and has a first manifold fluidic line having a first fluidic line opening and being fluidically coupled to each of the first openings and has a second manifold fluidic line having a second fluidic line opening and being fluidically coupled to each of the second openings. The one or more gaskets are coupled to the flow cell manifold assembly and fluidically coupled to the first fluidic line opening and the second fluidic line opening. The flow cell interface is engagable with the one or more gaskets to establish a fluidic coupling between the system and the flow cell.

In accordance with a second implementation, an apparatus includes a flow cell and a flow cell manifold assembly. The flow cell has a channel and the flow cell defines a plurality of first openings fluidically coupled to the channel and arranged on a first side of the channel and a plurality of second openings fluidically coupled the channel and arranged on a second side of the channel. The flow cell manifold assembly is coupled to the flow cell and has a first manifold fluidic line having a first fluidic line opening and being fluidically coupled to each of the first openings and has a second manifold fluidic line having a second fluidic line opening and being fluidically coupled to each of the second openings.

In accordance with a third implementation, an apparatus includes a flow cell including a channel, a plurality of first openings fluidically coupled to the channel and arranged on a first side of the channel, and a plurality of second openings fluidically coupled to the channel and arranged on a second side of the channel.

In accordance with a fourth implementation, a method includes forming a flow cell having a channel and including a plurality of first openings fluidically coupled to the channel and arranged on a first side of the channel and a plurality of second openings fluidically coupled to the channel and arranged on a second side of the channel. The method includes coupling a flow cell manifold assembly to the flow cell and fluidically coupled to the first openings and the second openings.

In accordance with a fifth implementation, an apparatus includes a flow cell and a flow cell manifold assembly. The flow cell has a channel and a plurality of openings arranged along a longitudinal axis of the channel and the flow cell manifold assembly is fluidically coupled to the openings.

In accordance with a sixth implementation, an apparatus includes a flow cell including a first flow cell layer, a second flow cell layer, and a third flow cell layer. The first flow cell layer includes an inlet opening and an outlet opening and the second flow cell layer includes a channel and a fluidic line fluidically coupled to the outlet opening and to the channel at a plurality of locations. The inlet opening is fluidically coupled to the channel and the second flow cell layer is positioned between the first flow cell layer and the third flow cell layer.

In accordance with a seventh implementation, an apparatus includes a flow cell including a channel, a plurality of first openings fluidically coupled to the channel and arranged on a first side of the channel, and second openings fluidically coupled to the channel. One of the second openings is arranged at a first end of the channel and another one of the second openings is arranged at a second end of the channel.

In further accordance with the foregoing first, second, third, fourth, fifth, sixth, and/or seventh implementations, an apparatus and/or method may further include or comprise any one or more of the following:

In an implementation, the first openings are evenly spaced from one another and the second openings are evenly spaced from one another.

In another implementation, the first openings and the second openings are asymmetric.

In another implementation, a gap height of the channel is less than or equal to approximately 100 micrometers.

In another implementation, a gap height of the channel is less than or equal to approximately 75 micrometers.

In another implementation, a gap height of each of the first manifold fluidic line and the second manifold fluidic line is less than or equal to approximately 125 micrometers.

In another implementation, a gap height of each of the first manifold fluidic line and the second manifold fluidic line is less than or equal to approximately 100 micrometers.

In another implementation, at least some of the first openings are staggered relative to at least some of the second openings.

In another implementation, at least some of the first openings oppose at least some of the second openings.

In another implementation, the first manifold fluidic line has a portion that is substantially parallel to a longitudinal axis of the channel and the second manifold fluidic line has a portion that is substantially parallel to the longitudinal axis of the channel.

In another implementation, the channel has a first end and a second end and the first manifold fluidic line is at least partially adjacent the first end and spaced from the second end and the second manifold fluidic line is at least partially adjacent the second end and spaced from the first end.

In another implementation, the flow cell includes a plurality layers that define the channel, the first openings, and the second openings.

In another implementation, the channel is substantially rectangular.

In another implementation, the channel has a width of between approximately 4.0 millimeters and approximately 6.0 millimeters and has a length of between approximately 55.0 millimeters and approximately 67.0 millimeters.

In another implementation, the flow cell manifold assembly includes a laminate.

In another implementation, the laminate has a thickness of between approximately 100 micrometers and approximately 300 micrometers.

In another implementation, a gap height of the channel is different than a gap height of the first manifold fluidic line.

In another implementation, a gap height of the channel is less than a gap height of the first manifold fluidic line.

In another implementation, a gap height of the channel is between approximately 25 μm and approximately 75 μm and a gap height of the first manifold fluidic line is approximately 100 μm.

In another implementation, a gap height of the channel is between approximately 25 μm and approximately 75 μm and a gap height of the first manifold fluidic line is approximately 100 μm or greater.

In another implementation, the channel and the first manifold fluidic line have a volume of between approximately 13 microliters and approximately 30 microliters.

In another implementation, the flow cell manifold assembly includes a first laminate layer, a second laminate layer, and a third laminate layer and the first laminate layer includes the first fluidic line opening and the second fluidic line opening, the second laminate layer includes the first manifold fluidic line and the second manifold fluidic line, and the third laminate layer includes first ports fluidically coupled to the first manifold fluidic line and the first openings of the flow cell and second ports fluidically coupled to the second manifold fluidic line and the second openings of the flow cell.

In another implementation, the second laminate layer is positioned between the first laminate layer and the third laminate layer.

In another implementation, the channel is substantially rectangular.

In another implementation, the flow cell includes a first flow cell layer, a second flow cell layer, and a third flow cell layer, the first flow cell layer includes the first openings and the second openings, the second flow cell layer includes the channel and is coupled between the first flow cell layer and the third flow cell layer.

In another implementation, the second flow cell layer includes a plurality of notches fluidically coupled to the channel and aligned with the first openings and the second openings of the first flow cell layer.

In another implementation, the second flow cell layer includes an interposer.

In another implementation, the third flow cell layer is solid.

In another implementation, the third flow cell layer does not include openings.

In another implementation, the first flow cell layer has a thickness of approximately 700 micrometers, the second flow cell layer has a thickness of approximately 25 micrometers, and the third flow cell layer has a thickness of approximately 700 micrometers.

In another implementation, a gap that defines the channel is formed between the first flow cell layer and the third flow cell layer and a height of the gap is between approximately 25 micrometers and approximately 75 micrometers.

In another implementation, the apparatus includes a flow cell manifold coupled to the first flow cell layer and having fluidic channels fluidically coupled to the openings of the first flow cell layer.

In another implementation, the flow cell manifold includes a laminate.

In another implementation, the laminate includes a first laminate layer, a second laminate layer, and a third laminate layer and the second laminate layer is coupled between the first laminate layer and the third laminate layer.

In another implementation, the first laminate layer includes a first fluidic line opening and a second fluidic line opening, the second laminate layer includes a first manifold fluidic line fluidically coupled to the first fluidic line opening and a second manifold fluidic line fluidically coupled to the second fluidic line opening, and the third laminate layer includes first ports fluidically coupled to the first manifold fluidic line and the first openings of the flow cell and second ports fluidically coupled to the second manifold fluidic line and the second openings of the flow cell.

In another implementation, the flow cell includes a second channel including a plurality of the first openings fluidically coupled to the second channel and arranged on a first side of the second channel and a plurality of the second openings fluidically coupled to the second channel and arranged on a second side of the second channel.

In another implementation, the apparatus includes a flow cell manifold coupled to the flow cell and having fluidic channels fluidically coupled to the first openings and the second openings of the channel and the second channel

In another implementation, the flow cell includes a second channel and the flow cell manifold assembly further includes a manifold opening and a plurality of fluidic lines fluidically coupled to the manifold opening, the channel, and the second channel.

In another implementation, the apparatus includes a gasket coupled to the manifold opening.

In another implementation, the method includes forming the flow cell including coupling a plurality of flow cell layers that define the channel and the first openings and the second openings.

In another implementation, coupling the flow cell manifold assembly to the flow cell includes coupling a laminate to a surface of the flow cell.

In another implementation, the laminate includes a first laminate layer, a second laminate layer, and a third laminate layer and the first laminate layer includes a first fluidic line opening and a second fluidic line opening, the second laminate layer includes a first manifold fluidic line fluidically coupled to the first fluidic line opening and a second manifold fluidic line fluidically coupled to the second fluidic line opening, and the third laminate layer includes first ports fluidically coupled to the first manifold fluidic line and the first openings of the flow cell and second ports fluidically coupled to the second manifold fluidic line and the second openings of the flow cell.

In another implementation, the first manifold fluidic line includes a first cross-section and a second-cross-section.

In another implementation, the first manifold fluidic line has a variable cross-section.

In another implementation, the flow cell manifold assembly includes a first laminate layer and a second laminate layer, and the first laminate layer includes the first fluidic line opening and the second fluidic line opening and the second laminate layer includes a channel that forms the first manifold fluidic line fluidically coupled to the first openings of the flow cell and a channel that forms the second manifold fluidic line fluidically coupled to the second openings of the flow cell.

In another implementation, the flow cell manifold assembly further includes a third laminate layer including first ports fluidically coupled to the first manifold fluidic line and the first openings of the flow cell and second ports fluidically coupled to the second manifold fluidic line and the second openings of the flow cell.

In another implementation, the flow cell manifold assembly further includes a fourth laminate layer including a channel that forms the first manifold fluidic line.

In another implementation, the channel of the fourth laminate layer aligns with the channel of the second laminate layer and forms the first manifold fluidic line.

In another implementation, the channel of the fourth laminate layer has a length that is shorter than a length of the channel of the second laminate layer.

In another implementation, the first manifold fluidic line includes a first cross-section and a second-cross-section.

In another implementation, the first manifold fluidic line has a variable cross-section.

In another implementation, a gap height of the channel is less than or equal to approximately 50 micrometers.

In another implementation, a gap height of the channel is less than or equal to approximately 25 micrometers.

In another implementation, a gap height of each of the first manifold fluidic line and the second manifold fluidic line is less than or equal to approximately 125 micrometers.

In another implementation, a gap height of each of the first manifold fluidic line and the second manifold fluidic line is greater than or equal to approximately 75 micrometers.

In another implementation, the second flow cell layer includes a second fluidic line fluidically coupled to the inlet opening and to the channel at a plurality of locations.

In another implementation, the first flow cell layer includes a second outlet opening and the second flow cell layer includes a second fluidic line fluidically coupled to the second outlet opening and to the channel at a plurality of locations.

In another implementation, the flow cell includes a notch at the first end and a notch at the second end.

In another implementation, the notches are asymmetric.

In another implementation, each of the notches has at two least sides having different lengths.

In another implementation, the flow cell manifold assembly includes a manifold fluidic line and a ratio of a gap height of the channel and a gap height of the manifold fluidic line is 1:6.

In another implementation, the flow cell manifold assembly includes a manifold fluidic line and a ratio of a gap height of the channel and a gap height of the manifold fluidic line is between 1:5 and 1:7.

In another implementation, the flow cell manifold assembly includes a manifold fluidic line and a ratio of a gap height of the channel and a gap height of the manifold fluidic line is between 1:4 and 1:8.

In another implementation, a ratio of a gap height of the channel and a gap height of the fluidic line is 1:6.

In another implementation, a ratio of a gap height of the channel and a gap height of the fluidic line is between 1:5 and 1.7.

In another implementation, a ratio of a gap height of the channel and a gap height of the fluidic line is between 1:4 and 1.8.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is an example implementation of a flow cell assembly that can be used to implement the flow cell assembly of FIG. 1.

FIG. 3 is an exploded view of the flow cell of FIG. 2 showing the first flow cell layer, the second flow cell layer, and the third flow cell layer.

FIG. 4 is an exploded view of the flow cell manifold assembly of FIG. 2 including the first laminate layer, the second laminate layer, and the third laminate layer.

FIG. 5 is an exploded view of another flow cell manifold assembly that can be used with the flow cell assembly of FIG. 1, the flow cell assembly of FIG. 2, and/or with any of the disclosed implementations.

FIG. 6 is a plan view of another flow cell assembly that can be used to implement the flow cell assembly of FIG. 1.

FIG. 7 is a plan view of another flow cell assembly that can be used to implement the flow cell assembly of FIG. 1.

FIG. 8 is an isometric view of the flow cell assembly of FIG. 7.

FIG. 9 illustrates a flowchart for a method of assembling the flow cell manifold assemblies of FIGS. 1-8 or any of the disclosed implementations.

FIG. 10 is a plan view of another flow cell assembly that can be used to implement the flow cell assembly of FIG. 1.

FIG. 11 is a plan view of another flow cell assembly that can be used to implement the flow cell assembly of FIG. 1.

FIG. 12 is a plan view of another flow cell assembly that can be used to implement the flow cell assembly of FIG. 1.

FIG. 13 is a plan view of another flow cell assembly that can be used to implement the flow cell assembly of FIG. 1.

FIG. 14 is a plan view of another flow cell assembly that can be used to implement the flow cell assembly of FIG. 1.

FIG. 15 is a plan view of another flow cell assembly that can be used to implement the flow cell assembly of FIG. 1.

FIG. 16 is a plan view of another flow cell assembly that can be used to implement the flow cell assembly of FIG. 1.

FIG. 17 is a plan view of another flow cell assembly that can be used to implement the flow cell assembly of FIG. 1.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

As least one aspect of this disclosure is directed toward flow cell assemblies including a flow cell having one or more channels and a flow cell manifold assembly coupled to the flow cell. The flow cell and/or the flow cell manifold assembly includes a plurality of openings that are arranged along and on either side of a longitudinal axis of each of the channels and are fluidically coupled to the corresponding channel. As a result, the disclosed implementations improve reagent flushing at edges of the channels of the flow cell and reduce impedance across the channels of the flow cell.

Advantageously, using the disclosed implementations, a height of a gap defining the channel may be reduced and the pressure drop can be maintained below a threshold value. Moreover, using the disclosed implementations reduces reagent consumption and enables higher flow rates associated with faster fluidics and lower run times. The term “impedance” refers to a ratio between the pressure drop and the flow rate and a threshold value for the pressure within the flow cell may be approximately 15 pounds-per-square-inch (psi).

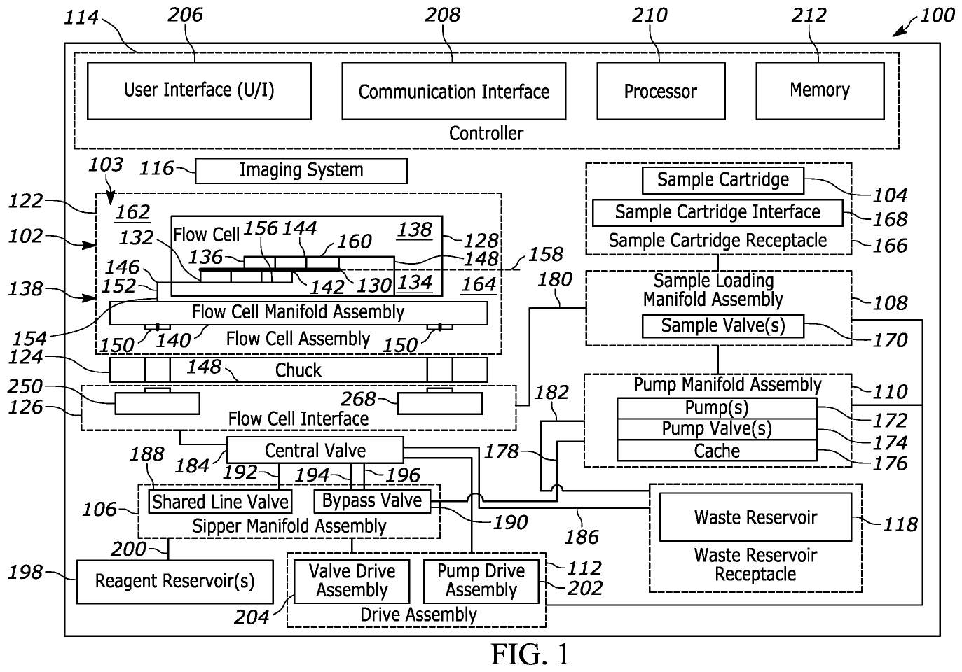

FIG. 1 illustrates a schematic diagram of an implementation of a system 100 in accordance with the teachings of this disclosure. The system 100 can be used to perform an analysis on one or more samples of interest. The sample may include one or more DNA clusters that have been linearized to form a single stranded DNA (sstDNA). In the implementation shown, the system 100 is adapted to receive a flow cell cartridge assembly 102 including a flow cell assembly 103 and a sample cartridge 104 and includes, in part, a sipper manifold assembly 106, a sample loading manifold assembly 108, and a pump manifold assembly 110. The system 100 also includes a drive assembly 112, a controller 114, an imaging system 116, and a waste reservoir 118. The controller 114 is electrically and/or communicatively coupled to the drive assembly 112 and to the imaging system 116 and is adapted to cause the drive assembly 112 and/or the imaging system 116 to perform various functions as disclosed herein.

The system 100 includes a flow cell receptacle 122 that receives the flow cell cartridge assembly 102, a vacuum chuck 124 that supports the flow cell assembly 103, and a flow cell interface 126 that is used to establish a fluidic coupling between the system 100 and the flow cell assembly 103. The flow cell interface 126 may include one or more manifolds.

Referring initially to the flow cell assembly 103, in the implementation shown, the flow cell assembly 103 includes a flow cell 128 having a channel 130 and defining a plurality of first openings 132 fluidically coupled to the channel 130 and arranged on a first side 134 of the channel 130 and defining a plurality of second openings 136 fluidically coupled to the channel 130 and arranged on a second side 138 of the channel 130. As used herein, a “flow cell” (also referred to as a flowcell) can include a device having a lid extending over a reaction structure to form a flow channel therebetween that is in communication with a plurality of reaction sites of the reaction structure. Some flow cells may also include a detection device that detects designated reactions that occur at or proximate to the reaction sites. While the flow cell 128 is shown including one of the channels 130, the flow cell 128 may include any number of channels 130 (e.g., 2, 3, 4, 5, 9).

The flow cell assembly 103 also includes a flow cell manifold assembly 140 coupled to the flow cell 128 and having a first manifold fluidic line 142 and a second manifold fluidic line 144. The flow cell manifold assembly 140 may be a laminate including a plurality of layers as discussed in more detail below.

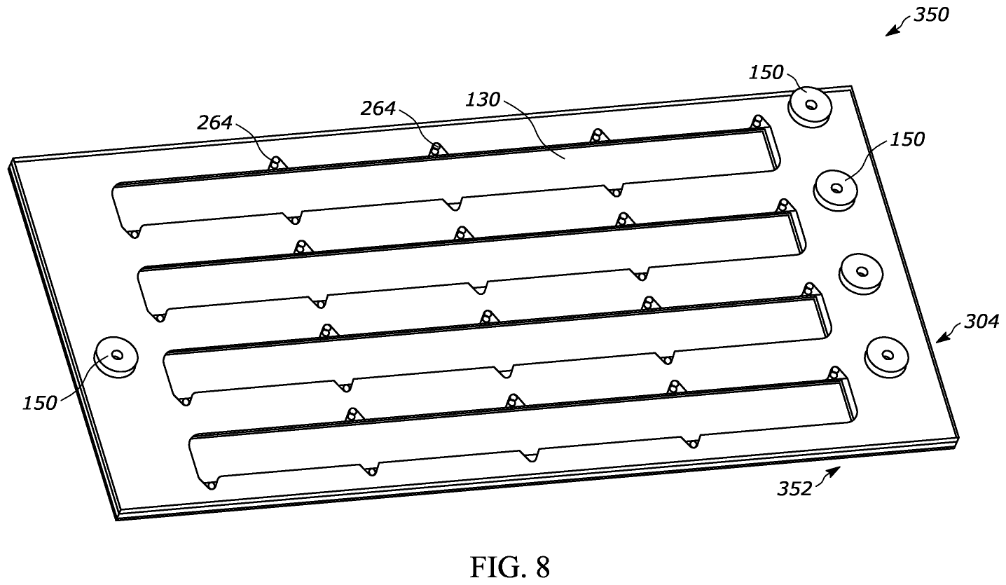

In the implementation shown, the first manifold fluidic line 142 has a first fluidic line opening 146 and is fluidically coupled to each of the first openings 132 of the flow cell 128 and the second manifold fluidic line 144 has a second fluidic line opening 148 and is fluidically coupled to each of the second openings 136. As shown, the flow cell assembly 103 includes gaskets 150 coupled to the flow cell manifold assembly 140 and fluidically coupled to the first fluidic line opening 146 and the second fluidic line opening 148. Each of the fluidic line openings 146, 148 can have one of the gaskets 150 that is aligned therewith or that is otherwise in fluidic communication therewith. In some implementations when the flow cell 128 includes a plurality of the channels 130, the flow cell manifold assembly 140 can include additional fluidic lines 152 that couple the first fluidic line openings 146 to a single manifold port 154. In such implementations, a single gasket 150 can be coupled to the flow cell manifold assembly 140 that surrounds the manifold port 154 and is in fluidic communication with a plurality of the channels 130 (see, for example, FIG. 8).

In operation, the flow cell interface 126 engages with the corresponding gaskets 150 to establish a fluidic coupling between the system 100 and the flow cell 128. The engagement between the flow cell interface 126 and the gaskets 150 reduces or eliminates fluid leakage between the flow cell interface 126 and the flow cell 128.

Referring still to the flow cell assembly 103, in the implementation shown, the first openings 132 are evenly spaced and the second openings 136 are evenly spaced and the first openings 132 are asymmetric and/or staggered relative to the second openings 136. In other implementations, the spacing between the first openings 132 may not be the same and/or similar and/or the spacing between the second openings 136 may not be the same and/or similar. Alternatively and as shown in FIG. 7, at least some of the first openings 132 may be asymmetric and/or oppose at least some of the second openings 136. In some implementations, greater flushing of the channel 130 may be achieved when the openings 132, 136 are staggered as compared to when the openings 132, 136 oppose one another. Other arrangements may prove suitable, however.

The cross-section of the openings 132 and/or 136 may be selected to reduce bubbles and/or to increase flow through the channel 130. The cross-section of one or more of the openings 132, 136 may be the same, similar, and/or different to others of the openings 132, 136. In some implementations, the openings 132 and/or 136 may have any suitable cross-section such as a circle cross-section, an oblong cross-section, a rectangular and/or slot-like cross section, etc. While the flow cell 128 is shown including four of the first openings 132 and four of the second openings 136, the flow cell 128 may include any number of openings on either side 134, 138 of the channel 130 including, for example, different numbers of the openings 132, 136 on the sides 134, 138 of the channel 130. For example, one opening can be positioned on one side 134 and/or 138 of the channel 130 and more than one opening can be positioned on another side 134 and/or 138.

In the implementation shown, the first manifold fluidic line 142 has a portion 156 that is substantially parallel to a longitudinal axis 158 of the channel 130 and the second manifold fluidic line 144 has a portion 160 that is substantially parallel to the longitudinal axis 158 of the channel 130. Additionally, the first manifold fluidic line 142 is shown being at least partially adjacent a first end 162 of the flow cell 128 and spaced from a second end 164 of the flow cell 128 and the second manifold fluidic line 144 is shown being at least partially adjacent the second end 164 of the flow cell 128 and spaced from the first end 162. Other arrangements of the manifold fluidic lines 142, 144 may prove suitable, however.

Referring now to the sample cartridge 104, the sample loading manifold assembly 108, and the pump manifold assembly 110, in the implementation shown, the system 100 includes a sample cartridge receptacle 166 that receives the sample cartridge 104 that carries one or more samples of interest (e.g., an analyte). The system 100 also includes a sample cartridge interface 168 that establishes a fluidic connection with the sample cartridge 104.

The sample loading manifold assembly 108 includes one or more sample valves 170 and the pump manifold assembly 110 includes one or more pumps 172, one or more pump valves 174, and a cache 176. One or more of the valves 170, 174 may be implemented by a rotary valve, a pinch valve, a flat valve, a solenoid valve, a check valve, a piezo valve, and/or a three-way valve. Different types of fluid control devices may be used, however. One or more of the pumps 172 may be implemented by a syringe pump, a peristaltic pump, and/or a diaphragm pump. Other types of fluid transfer devices may be used, however. The cache 176 may be a serpentine cache and may temporarily store one or more reaction components during, for example, bypass manipulations of the system 100 of FIG. 1. While the cache 176 is shown being included in the pump manifold assembly 110, in another implementation, the cache 176 may be located in a different location. For example, the cache 176 may be included in the sipper manifold assembly 106 or in another manifold downstream of a bypass fluidic line 178.

The sample loading manifold assembly 108 and the pump manifold assembly 110 flow one or more samples of interest from the sample cartridge 104 through a fluidic line 180 toward the flow cell cartridge assembly 102. In some implementations, the sample loading manifold assembly 108 can individually load/address each channel 130 of the flow cell 128 with a sample of interest. The process of loading the channel 130 with a sample of interest may occur automatically using the system 100 of FIG. 1.

As shown in the system 100 of FIG. 1, the sample cartridge 104 and the sample loading manifold assembly 108 are positioned downstream of the flow cell cartridge assembly 102. The sample loading manifold assembly 108 may thus load a sample of interest into the flow cell 128 from the rear of the flow cell 128. Loading a sample of interest from the rear of the flow cell 128 may be referred to as “back loading.” Back loading the sample of interest into the flow cell 128 may reduce contamination. In the implementation shown, the sample loading manifold assembly 108 is coupled between the flow cell cartridge assembly 102 and the pump manifold assembly 110.

To draw a sample of interest from the sample cartridge 104 and toward the pump manifold assembly 110, the sample valves 170, the pump valves 174, and/or the pumps 172 may be selectively actuated to urge the sample of interest toward the pump manifold assembly 110. The sample cartridge 104 may include a plurality of sample reservoirs that are selectively fluidically accessible via the corresponding sample valve 170. Each sample reservoir can thus be selectively isolated from other sample reservoirs using the corresponding sample valves 170.

To individually flow the sample of interest toward the channel 130 of the flow cell 128 and away from the pump manifold assembly 110, the sample valves 170, the pump valves 174, and/or the pumps 172 can be selectively actuated to urge the sample of interest toward the flow cell cartridge assembly 102 and into the respective channels 130 of the flow cell 128. In implementations in which the flow cell 128 includes a plurality of the channels 130 (see, for example, FIG. 7), each channel 130 of the flow cell 128 can receive the sample of interest. In other implementations in which the flow cell 128 includes a plurality of the channels 130, one or more of the channels 130 selectively receive the sample of interest and others of the channels 130 do not receive the sample of interest. The channels 130 of the flow cell 128 that may not receive the sample of interest may receive a wash buffer instead, for example.

The drive assembly 112 interfaces with the sipper manifold assembly 106 and the pump manifold assembly 110 to flow one or more reagents that interact with the sample within the flow cell 128. In an implementation, a reversible terminator is attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. In the implementation shown, the imaging system 116 excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 116 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 112 interfaces with the sipper manifold assembly 106 and the pump manifold assembly 110 to flow another reaction component (e.g., a reagent) through the flow cell 128 that is thereafter received by the waste reservoir 118 via a primary waste fluidic line 182 and/or otherwise exhausted by the system 100. Some reaction components perform a flushing operation that chemically cleaves the fluorescent label and the reversible terminator from the sstDNA. The sstDNA is then ready for another cycle.

The primary waste fluidic line 182 is coupled between the pump manifold assembly 110 and the waste reservoir 118. In some implementations, the pumps 172 and/or the pump valves 174 of the pump manifold assembly 110 selectively flow the reaction components from the flow cell cartridge assembly 102, through the fluidic line 180 and the sample loading manifold assembly 108 to the primary waste fluidic line 182.

The flow cell cartridge assembly 102 is coupled to a central valve 184 via the flow cell interface 126. An auxiliary waste fluidic line 186 is coupled to the central valve 184 and to the waste reservoir 118. In some implementations, the auxiliary waste fluidic line 186 receives excess fluid of a sample of interest from the flow cell cartridge assembly 102, via the central valve 184, and flows the excess fluid of the sample of interest to the waste reservoir 118 when back loading the sample of interest into the flow cell 128, as described herein. That is, the sample of interest may be loaded from the rear of the flow cell 128 and any excess fluid for the sample of interest may exit from the front of the flow cell 128. By back loading samples of interest into the flow cell 128 in implementations in which the flow cell 128 includes a plurality of the channels 130 allows different samples to be separately loaded to corresponding channels 130 and the fluidic lines 152 of the flow cell manifold assembly 140 coupled to the manifold port 154 can couple the flow cell 128 to the central valve 184 to direct excess fluid of each sample of interest to the auxiliary waste fluidic line 186. In such implementations, once the samples of interest are loaded into the flow cell 128, the flow cell manifold assembly 140 can be used to deliver common reagents from the front of the flow cell 128 (e.g., upstream) for each channel 130 that exit from the rear of the flow cell 128 (e.g., downstream). Put another way, the sample of interest and the reagents may flow in opposite directions through the channels 130 of the flow cell 128.

Referring to the sipper manifold assembly 106, in the implementation shown, the sipper manifold assembly 106 includes a shared line valve 188 and a bypass valve 190. The shared line valve 188 may be referred to as a reagent selector valve. The central valve 184 and the valves 188, 190 of the sipper manifold assembly 106 may be selectively actuated to control the flow of fluid through fluidic lines 192, 194, 196. One or more of the valves 184, 188, 190 may be implemented by a rotary valve, a pinch valve, a flat valve, a solenoid valve, a check valve, a piezo valve, etc. Other fluid control devices may prove suitable.

The sipper manifold assembly 106 may be coupled to a corresponding number of reagents reservoirs 198 via reagent sippers 200. The reagent reservoirs 198 may contain fluid (e.g., reagent and/or another reaction component). In some implementations, the sipper manifold assembly 106 includes a plurality of ports. Each port of the sipper manifold assembly 106 may receive one of the reagent sippers 200. The reagent sippers 200 may be referred to as fluidic lines.

The shared line valve 188 of the sipper manifold assembly 106 is coupled to the central valve 184 via the shared reagent fluidic line 196. Different reagents may flow through the shared reagent fluidic line 196 at different times. In an implementation, when performing a flushing operation before changing between one reagent and another, the pump manifold assembly 110 may draw wash buffer through the shared reagent fluidic line 196, the central valve 184, and the flow cell cartridge assembly 102. The shared reagent fluidic line 196 may thus be involved in the flushing operation. While one shared reagent fluidic line 196 is shown, any number of shared fluidic lines may be included in the system 100.

The bypass valve 190 of the sipper manifold assembly 106 is coupled to the central valve 184 via the dedicated reagent fluidic lines 194, 196. The central valve 184 may have one or more dedicated ports that correspond to the dedicated reagent fluidic lines 194, 196. Each of the dedicated reagent fluidic lines 194, 196 may be associated with a single reagent. The fluids that may flow through the dedicated reagent fluidic lines 194, 196 may be used during sequencing operations and may include a cleave reagent, an incorporation reagent, a scan reagent, a cleave wash, and/or a wash buffer. Thus, when performing a flushing operation before changing between one reagent and another in association with the bypass valve 190, the sipper manifold assembly 106 may draw wash buffer through the central valve 184 and/or the flow cell cartridge assembly 102. However, because only a single reagent may flow through each of the dedicated reagent fluidic lines 194, 196, the dedicated reagent fluidic lines 194, 196 themselves may not be flushed. The approach of including dedicated reagent fluidic lines 194, 196 may be advantageous when the system 100 uses reagents that may have adverse reactions with other reagents. Moreover, reducing a number of fluidic lines or length of the fluidic lines that are flushed when changing between different reagents reduces reagent consumption and flush volume and may decrease cycle times of the system 100. While two dedicated reagent fluidic lines 194, 196 are shown, any number of dedicated fluidic lines may be included in the system 100.

The bypass valve 190 is also coupled to the cache 176 of the pump manifold assembly 110 via the bypass fluidic line 178. One or more reagent priming operations, hydration operations, mixing operations, and/or transfer operations may be performed using the bypass fluidic line 178. The priming operations, the hydration operations, the mixing operations, and/or the transfer operations may be performed independent of the flow cell cartridge assembly 102. Thus, the operations using the bypass fluidic line 178 may occur during, for example, incubation of one or more samples of interest within the flow cell cartridge assembly 102. That is, the shared line valve 188 can be utilized independently of the bypass valve 190 such that the bypass valve 190 can utilize the bypass fluidic line 178 and/or the cache 176 to perform one or more operations while the shared line valve 188 and/or the central valve 184 simultaneously, substantially simultaneously, or offset synchronously perform other operations. The system 100 can thus perform multiple operations at once, thereby reducing run time.

Referring now to the drive assembly 112, in the implementation shown, the drive assembly 112 includes a pump drive assembly 202 and a valve drive assembly 204. The pump drive assembly 202 may be adapted to interface with the one or more pumps 172 to pump fluid through the flow cell 128 and/or to load one or more samples of interest into the flow cell 128. The valve drive assembly 204 may be adapted to interface with one or more of the valves 170, 174, 184, 188, 190 to control the position of the corresponding valves 170, 174, 184, 188, 190.

Referring to the controller 114, in the implementation shown, the controller 114 includes a user interface 206, a communication interface 208, one or more processors 210, and a memory 212 storing instructions executable by the one or more processors 210 to perform various functions including the disclosed implementations. The user interface 206, the communication interface 133, and the memory 212 are electrically and/or communicatively coupled to the one or more processors 210.

In an implementation, the user interface 206 is adapted to receive input from a user and to provide information to the user associated with the operation of the system 100 and/or an analysis taking place. The user interface 206 may include a touch screen, a display, a key board, a speaker(s), a mouse, a track ball, and/or a voice recognition system. The touch screen and/or the display may display a graphical user interface (GUI).

In an implementation, the communication interface 208 is adapted to enable communication between the system 100 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 210 and/or the system 100 may include one or more of a processor-based system(s) or a microprocessor-based system(s). In some implementations, the one or more processors 210 and/or the system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

The memory 212 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

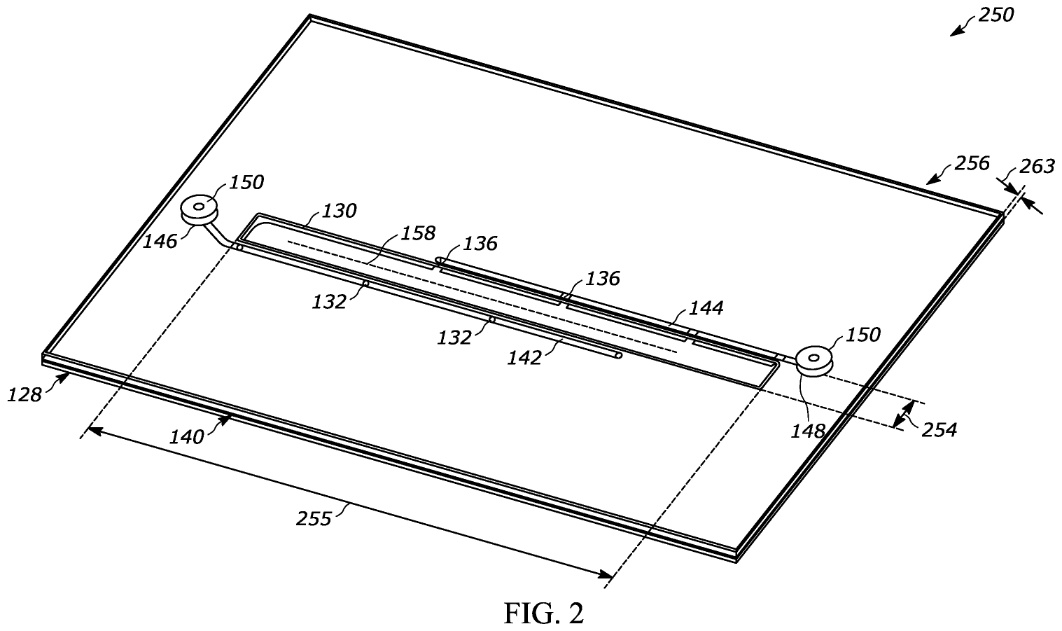

FIG. 2 is an example implementation of a flow cell assembly 250 that can be used to implement the flow cell assembly 103 of FIG. 1. In the implementation shown, the flow cell assembly 250 includes the flow cell 128 including the channel 130, the plurality of openings 132, 136 and the flow cell manifold assembly 140 coupled to the flow cell 128 and having the first manifold fluidic line 142 fluidically coupled to each of the first openings 132 and having the second manifold fluidic line 144 fluidically coupled to each of the second openings 136. The gaskets 150 are also shown coupled to the flow cell manifold assembly 140 and fluidically coupled to the fluidic line openings 146, 148. The gaskets 150 may be adhesive backed elastomers that can adhere to the flow cell manifold assembly 140 and/or the flow cell 128. The gasket 150 include or can otherwise be formed from a silicone elastomer, a silicon sheet, Dynaflex™ G7702 (TPE), a platinum cured silicone, Santoprene 8281-35 (TPV), thermoplastic elastomers, polypropylene based polymers, synthetic rubbers, thermoplastic vulcanizate, etc.

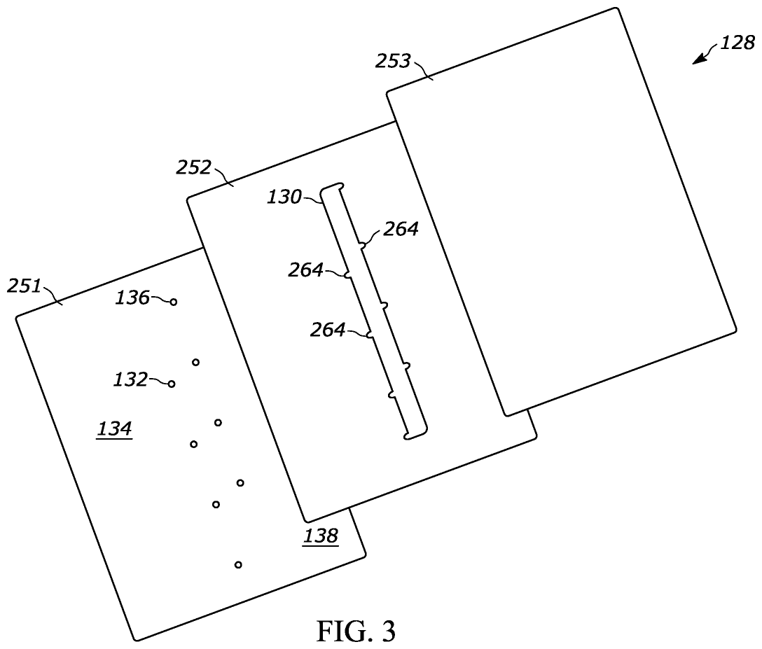

In the implementation shown, the flow cell 128 includes a plurality of flow cell layers 251, 252, 253 (see. FIG. 3) that define the channel 130, the first openings 132, and the second openings 136. While three flow cell layers 251, 252, 253 are mentioned, the flow cell 128 may include any number of layers including, for example, two layers, four layers, etc.

Referring still to the flow cell 128, the channel 130 is shown being substantially rectangular and having a width 254 of between approximately 4.0 millimeters (mm) and approximately 6.0 mm and having a length 255 of between approximately 64.0 mm and approximately 67.0 mm. More specifically, in some implementations, the width 254 is approximately 4.58 mm, approximately 4.688 mm, and/or approximately 5.224 mm and the length 255 is approximately 55.0 mm, approximately 64.284 mm, and/or approximately 67.0 mm. In such implementations, the impedance of the channel 128 may be between approximately 0.5 PSI*min/ML and approximately 3 PSI*min/ML or, more specifically, approximately 0.62 PSI*min/ML, approximately 1.35 PSI*min/ML, approximately 1.6 PSI*min/ML, approximately 2.86 PSI*min/ML, and/or approximately 3.34 PSI*min/ML. The channel 130 may have a different shape such as a polygon and/or a hexagon and have any suitable dimensions. Moreover, the channels 130 having different impedances may prove suitable.

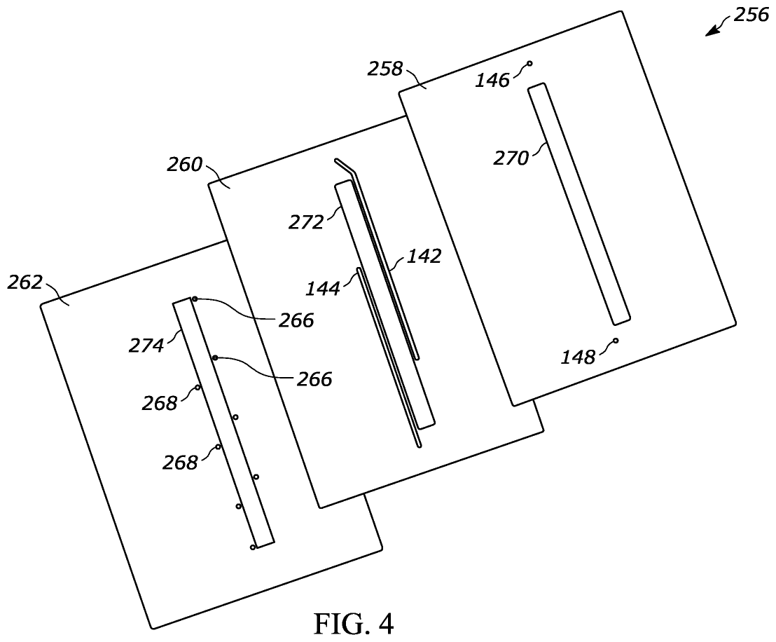

In the implementation shown, the flow cell manifold assembly 140 is shown being a laminate 256 having a plurality of laminate layers 258, 260, 262 (See, FIG. 4). While three laminate layers 258, 260, 262 are mentioned, the laminate 256 may include any number of layers including, for example, two layers. The laminate 256 can have a thickness 263 of between approximately 100 micrometer and approximately 300 micrometers. Other laminates may have different thicknesses depending on the application. For example, the laminate 256 may have a greater thickness to enable the manifold fluidic lines 142, 144 to have a greater gap height. Alternatively, the flow cell manifold assembly 140 may not be a laminate.

Referring still to the flow cell assembly 250, the manifold fluidic lines 142, 144 are shown being substantially parallel to the longitudinal axis 158 of the channel 128 and may have a different and/or larger gap height than the channel 130. By sizing the manifold fluidic lines 142 and/or 144 to have a different gap height than the channel 130, greater flow rates may be achieved through the manifold fluidic lines 142, 144 that encourages flushing at the edges of the channel 130 while allowing the gap height of the channel 130 to be kept at a threshold value that enables reduced reagent consumption. The gap height of the channel 130 may be approximately 25 μm, approximately 45 μm, and/or approximately 75 μm and the gap height of the manifold fluidic lines 142 and/or 144 may be approximately 100 μm, approximately 125 μm, and/or approximately 150 μm. A ratio between the gap height of the channel 130 and the gap height of the manifold fluidic lines 142 and/or 144 may be 1:4, 1:5, 1:6 1:7, and/or 1.8. The gap height of the channel 130 in such implementations may be approximately 25 μm and the gap height of the manifold fluidic lines 142 and/or 144 may be approximately 150 μm Other gap heights for the channel 130 and/or the manifold fluidic lines 142 and/or 144 may prove suitable including the channel 130 and one or more of the manifold fluidic lines 142 and/or 144 having the same gap height. Moreover, the gap height and/or cross-section of the manifold fluidic lines 142 and/or 144 may change and/or be different along a length of the manifold fluidic lines 142 and/or 144 to achieve, for example, different flow rates, flush rates.

FIG. 3 is an exploded view of the flow cell 128 of FIG. 2 showing the first flow cell layer 251, the second flow cell layer 252, and the third flow cell layer 253. The second flow cell layer 252 may be referred to as a interposer. In the implementation shown, the first flow cell layer 251 includes the first openings 132 and the second openings 136 and the second flow cell layer 252 includes the channel 130. The second flow cell layer 252 also includes a plurality of notches 264 that are fluidically coupled to the channel 130. The third flow cell layer 253 is shown as being solid and not including any openings. Other arrangements may prove suitable, however. For example, the third flow cell layer 253 may include the openings 132, 136 and the first flow cell layer 251 may be solid and/or not include the openings 132, 136.

In some implementations, the first flow cell layer 251 has a thickness of approximately 700 micrometers, the second flow cell layer 252 has a thickness of approximately 25 micrometers, and the third flow cell layer 253 has a thickness of approximately 700 micrometers. However, any of the flow cell layers 251, 252, 253 may have any suitable thickness that may be similar, the same, or different than others of the flow cell layers 251, 252, 253.

When the flow cell layers 251, 252, 253 are coupled together, the second flow cell layer 252 is coupled between the first flow cell layer 251 and the third flow cell layer 253, the first openings 132 are positioned on the first side 134 of the channel 130 and the second openings 136 are positioned on the second side 138 of the channel 130, and the notches 264 are aligned with the first openings 132 and the second openings 136 of the first flow cell layer. 24. When the flow cell layers 251, 252, 253 are coupled, the gap that defines the channel 130 is formed between the first flow cell layer 251 and the third flow cell layer 253 and the gap height can be between approximately 25 μm and approximately 75 μm. In some implementations, the gap height of the channel 130 is less than or equal to approximately 100 micrometers and/or less than or equal to approximately 75 micrometers.

FIG. 4 is an exploded view of the flow cell manifold assembly 140 of FIG. 2 including the first laminate layer 258, the second laminate layer 260, and the third laminate layer 262. In the implementation shown, the first laminate layer 258 includes the first fluidic line opening 146 and the second fluidic line opening 148. The fluidic line openings 146, 148 provide a single common inlet and a single common outlet for the flow cell 128 that allows the flow cell 128 to be easily integrated with systems such as the system 100 of FIG. 1.

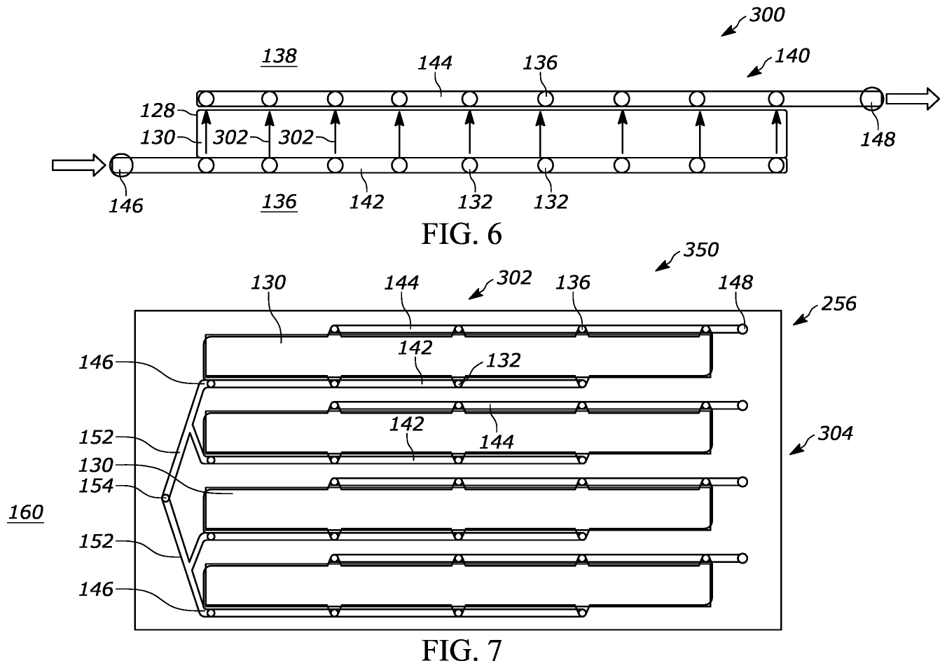

The second laminate layer 260 includes the first manifold fluidic line 142 and the second manifold fluidic line 144 that are each formed as channels through the second laminate layer 260 and the third laminate includes first ports 266 and second ports 268 that together with the manifold fluidic lines 142, 144 allow parallel flow paths to be created across the channel 130 and between the ports 266, 268 (see, for example, FIG. 6). The ports 266, 268 are arranged to align with and be fluidically coupled with the openings 132, 136 of the flow cell 128 when the flow cell 128 and the flow cell manifold assembly 140 are coupled. As also shown, each of the laminate layers 258, 260, 262 includes an opening 270, 272, 274 that align when the laminate layers 258, 260, 262 are coupled with one another and allow visual access to the channel 130 of the flow cell 128 and/or for imaging and water immersion optics.

When the laminate layers 258, 260, 262 are coupled together, the second laminate layer 260 is coupled between the first laminate layer 258 and the third laminate layer 262, the first manifold fluidic line 142 is fluidically coupled to the first fluidic line opening 146 and the first ports 266, and the second manifold fluidic line 144 is fluidically coupled to the second fluidic line opening 148 and the second ports 268. In some implementations, a gap height of the first manifold fluidic line 142 and/or the second manifold fluidic line 144 is less than or equal to approximately 125 micrometers and/or is less than or equal to approximately 100 micrometers. However, in other implementations, the manifold fluidic lines 142 may have any gap height (e.g., greater than 100 micrometers, greater 100 micrometers).

While the flow cell manifold assembly 140 is shown including the three laminate layers 258, 260, 262, in other implementations, the flow cell manifold assembly 140 may have another number of layers. For example, in some implementations, the third laminate layer 262 is omitted, thereby allowing the second laminate layer 260 to be coupled directly to the flow cell 128 and for the manifold fluidic lines 142, 144 to cover the openings 132, 136 of the flow cell 128.

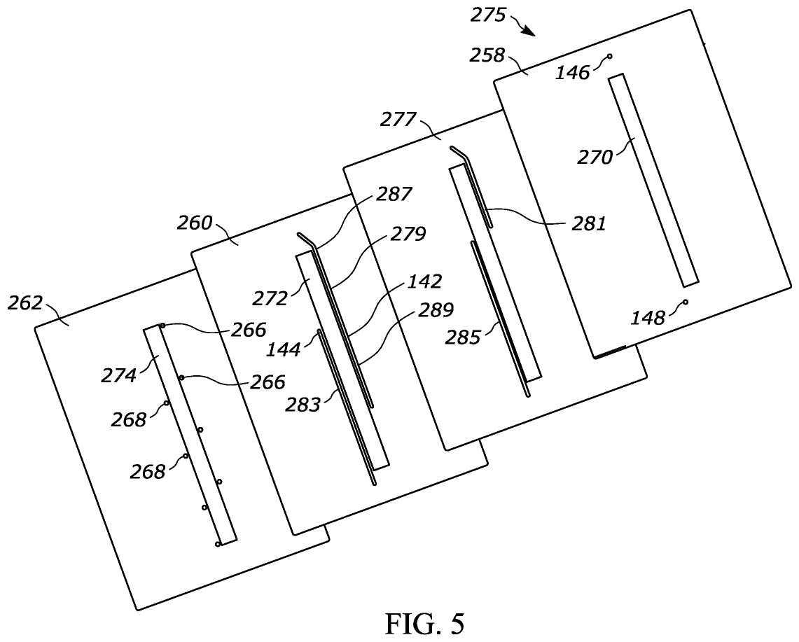

FIG. 5 is an exploded view of another flow cell manifold assembly 275 that can be used with the flow cell assembly 103 of FIG. 1, the flow cell assembly 250 of FIG. 2, and/or with any of the disclosed implementations. The flow cell manifold assembly 275 is similar to the flow cell manifold assembly 140 of FIG. 4. However, in contrast, the flow cell manifold assembly 275 includes a fourth laminate layer 277 that is positioned between the first laminate layer 258 and the second laminate layer 260. In the implementation shown, the first manifold fluidic line 144 is formed by a channel 279 defined by the second laminate layer 260 and a channel 281 defined by fourth laminate layer 277 and the second manifold fluidic line 146 is formed by a channel 283 defined by the second laminate layer 260 and a channel 285 defined by the fourth laminate layer 275.

When the laminate layers 258, 260, 262, 275 are coupled together, the channels 279, 281 of the second and fourth laminate layers 260, 275 align to form the first manifold fluidic line 142 and the channels 283, 283 of the second and fourth laminate layers 260, 275 align to form the second manifold fluidic line 144. The channels 279, 281 being aligned allows a first portion 287 of the first manifold fluidic line 142 to have a first cross-section and for a second portion 289 of the first manifold fluidic line 270 to have a second cross-section that is different than the first cross-section. The first cross-section may be greater than the second cross-section, thereby allowing greater flow through the first portion 287 of the fluid manifold fluidic line 142. The first portion 287 of the first manifold fluidic line 142 having the first cross-section may allow fluid to flow into the first end 162 of the channel 130 and to flow into the second portion 285 of the first manifold fluidic line 142 having the second cross-section that flows fluid into the second end 164 of the channel 130. The first manifold fluidic line 142 thus has a variable cross-section. While the channel 283, 285 are shown being the same or similar lengths, in other implementations, the channel 285 may be omitted. Also, while the channel 281 is shown being shorter than the channel 279, the channel 281 may be longer than shown, shorter than shown, and/or the same or a similar length as the channel 279.

FIG. 6 is a plan view of another flow cell assembly 300 that can be used to implement the flow cell assembly 103 of FIG. 1. The flow cell assembly 300 of FIG. 6 is similar to the flow cell assembly 250 of FIG. 2 in that the flow cell assembly 300 includes the common first fluidic line opening 146 and the common second fluidic line opening 148 that allow the flow cell assembly 300 to easily interface with the system 100 of FIG. 1. In contrast to the flow cell assembly 250 of FIG. 2, however, the flow cell 128 and the flow cell manifold assembly 140 of FIG. 6 includes additional openings 132 and 136 on each side 134, 138 of the flow cell 128 that oppose one another. FIG. 6 also shows flow paths 302 across the channel 130 and between the opposing openings 132, 136. The flow paths 302 are shown being substantially parallel to one another. As set forth herein, substantially parallel means about 5 degrees of parallel including parallel itself. Deviation of how the flow actually occurs across the channel 130 is possible, however.

FIG. 7 is a plan view of another flow cell assembly 350 that can be used to implement the flow cell assembly 103 of FIG. 1. The flow cell assembly 350 of FIG. 7 is similar to the flow cell assembly 250 of FIG. 2. However, in contrast, the flow cell assembly 350 of FIG. 7 includes a flow cell 352 having a plurality of the channels 130, where at least some of the openings 132, 136 of the channels 130 are shown opposing one another. In addition and in contrast to the flow cell assembly 250 of FIG. 2, the flow cell assembly 350 of FIG. 7 includes a flow cell manifold assembly 354 including one of the first manifold fluidic lines 142 and one of the second manifold fluidic lines 144 for each of the channels 130. The flow cell assembly 350 of FIG. 3 also includes the fluidic lines 152 that are coupled between the manifold port 154 and the first fluidic line openings 146 of each of the channels 130. As such, fluid can flow between the channels 130 and the single manifold port 154 using the fluidic lines 152, thereby allowing less valving to be used to control fluid flow through the flow cell assembly 350.

FIG. 8 is an isometric view of the flow cell assembly 350 of FIG. 7 illustrating the channels 130, the notches 264 that are fluidically coupled to the channels 130, and the gaskets 150 coupled to the flow cell manifold assembly 354.

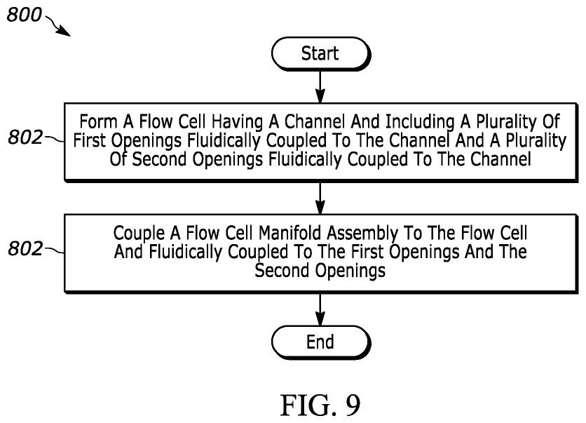

FIG. 9 illustrates a flowchart for a method of assembling the flow cell assemblies 103, 250, 350, or any of the disclosed implementations. The order of execution of the blocks may be changed, and/or some of the blocks described may be changed, eliminated, combined, and/or subdivided into multiple blocks.

The process 800 of FIG. 9 begins with the flow cell 128, 352 being formed having the channel 130 and the plurality of first openings 132 fluidically coupled to the channel 130 and the plurality of second openings 136 fluidically coupled to the channel 130 (Block 802). The first openings 132 are arranged on the first side 134 of the channel 130 and the second openings 136 are arranged on the second side 138 of the channel 130. In some implementations, the flow cell 128, 352 is formed by coupling a plurality of flow cell layers 251, 252, 253 together that define the channel 130, the first openings 132, and the second openings 136.

The flow cell manifold assembly 140, 354 is coupled to the flow cell 128, 352 and fluidically coupled to the first openings 132 and the second openings 136 (Block 804). In some implementations, coupling the flow cell manifold assembly 140, 354 to the flow cell 128, 352 includes coupling the laminate 256 to a surface of the flow cell 128, 352. The laminate 256 can include the first laminate layer 258, the second laminate layer 260, and the third laminate layer 262, where the first laminate layer 258 includes the first fluidic line opening 146 and the second fluidic line opening 144, the second laminate layer 260 includes the first manifold fluidic line 142 fluidically coupled to the first fluidic line opening 146 and the second manifold fluidic line 144 fluidically coupled to the second fluidic line opening 148, and the third laminate layer 262 includes the first ports 266 fluidically coupled to the first manifold fluidic line 142 and the first openings 132 of the flow cell 128, 352 and the second ports 268 fluidically coupled to the second manifold fluidic line 144 and the second openings 236 of the flow cell 128, 352.

FIG. 10 is a plan view of another flow cell assembly 1000 that can be used to implement the flow cell assembly 103 of FIG. 1. The flow cell assembly 1000 of FIG. 10 is similar to the flow cell assembly 300 of FIG. 6. However, in contrast, the channel 130 of the flow cell assembly 1000 of FIG. 10 includes one of the notches 264 coupled to a fluidic opening 1004. The flow cell assembly 1000 of FIG. 10 also has the first openings 132 fluidically coupled to the channel 130 and arranged on the first side 134 of the channel 130 and has the second openings 136 fluidically coupled to the channel 130 and arranged on the second side 138 of the channel 130. The fluidic opening 1004 is arranged as an inlet to the channel 130 and positioned at an end of a first portion 1005 of the channel 130 in the implementation shown and the first and second openings 132, 136 are arranged along a second portion 1006 of the channel 130 and as outlets to the channel 130. The first portion 1005 of the channel 130 does not include the openings 132, 136. The first portion 1005 and/or the second portion 1006 of the channel 130 can however include the openings 132, 135.

The flow cell assembly 1000 of FIG. 10 also includes the flow cell manifold assembly 140 having the first manifold fluidic line 142 coupled to each of the first openings 132 and the second manifold fluidic line 144 coupled to each of the second openings 136. The first manifold fluidic line 142 has the first fluidic line opening 146 that acts as a common outlet for the first manifold fluidic line 142 and the second manifold fluidic line 144 has the second fluidic line opening 148 that acts as a common outlet for the second manifold fluidic line 144.

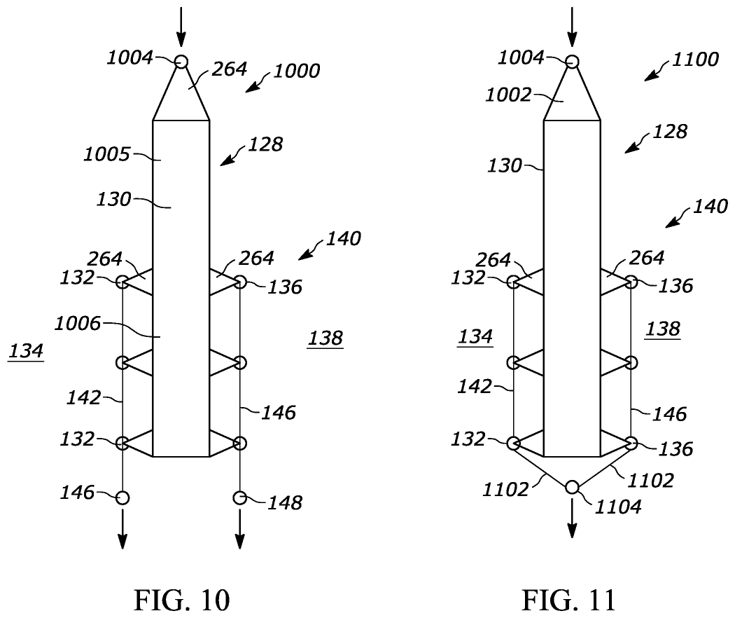

FIG. 11 is a plan view of another flow cell assembly 1100 that can be used to implement the flow cell assembly 103 of FIG. 1. The flow cell assembly 1100 of FIG. 11 is similar to the flow cell assembly 1000 of FIG. 10. However, in contrast, the flow cell manifold assembly 1100 of FIG. 11 includes additional fluidic lines 1102 that couple the first and second fluidic line openings 146, 148 to a single manifold port 1104.

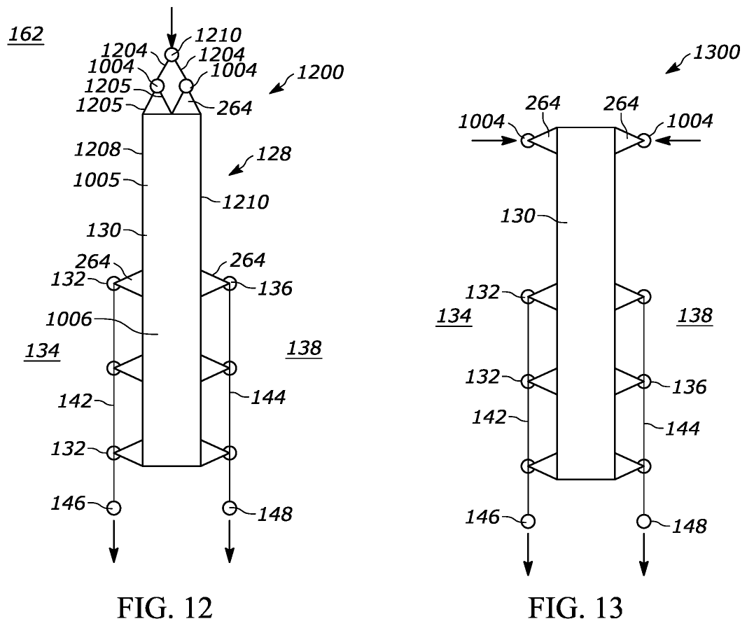

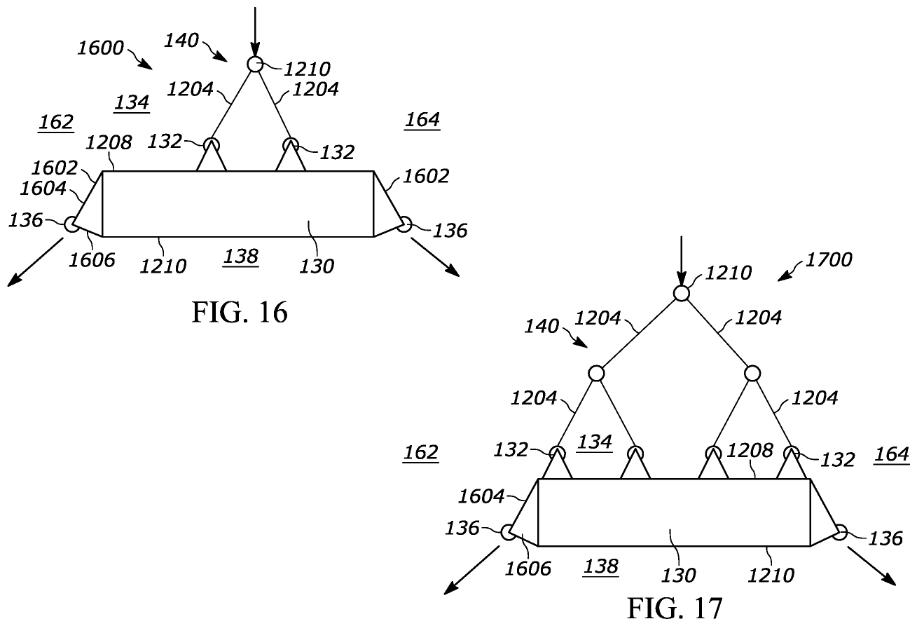

FIG. 12 is a plan view of another flow cell assembly 1200 that can be used to implement the flow cell assembly 103 of FIG. 1. The flow cell assembly 1200 of FIG. 12 is similar to the flow cell assembly 1000 of FIG. 10. However, in contrast, the flow cell 128 of the flow cell assembly 1200 of FIG. 12 includes a pair of the notches 264 at the first end 162 of the flow cell 128, with each notch 264 fluidically coupled to a corresponding inlet openings 1004. The notches 264 are shown having sides 1205 that are approximately the same length and thus the notches 264 are symmetric. The notches 264 may however be asymmetric and form, for example, a scalene triangle (see, for example, FIGS. 16 and 17). The multiple inlets 1004 and/or the position of the inlets 1004 may bias and/or encourage fluid to flow toward walls 1208, 1210 of the channel 130 and increase flushing efficiency. The notches 264 and/or the angle of the notches 264 may bias and/or encourage fluid to flow toward walls 1208, 1210 of the channel 130. The flow cell manifold assembly 140 includes additional fluidic lines 1204 that couple the first and second fluidic line openings 146, 148 to a single manifold port 1210.

While the flow cell assembly 1200 includes the flow cell manifold assembly 140. In other implementations, the flow cell manifold assembly 140 may be omitted and the flow cell 108 and/or the flow cell layers 251, 252, 253 may define the fluidic lines 142, 144, fluidic line openings 146, 148, and the inlet openings 1004, thereby allowing the fluidic lines 142, 144 to be in and/or substantially within the same plane as the channel 130. The first flow cell layer 251 in such an implementation may define the manifold port 1210 and the fluidic line openings 146, 148 and the second flow cell layer 252 may define the additional fluidic lines 1204 and the fluidic lines 142, 144. Any of the disclosed implementations may be modified in a manner such that the flow cell manifold assembly 140 is omitted and the flow cell 128 and/or the flow cell layers 251, 252, 253 define the fluidic lines and/or openings shown currently being defined by the flow cell manifold assembly 140.

For example, the first flow cell layer 251 can include an inlet opening 146, 1004, and/or 1210 and an outlet opening 148 and the second flow cell layer 252 can include a channel 130 and a fluidic line 144 fluidically coupled to the outlet opening 148 and to the channel 130 at a plurality of locations such as at the notches 264. The inlet opening 146 is fluidically coupled to the channel 130 in such implementations using a corresponding notch 264 and the second flow cell layer 252 is positioned between the first flow cell layer 251 and the third flow cell layer 253.

The second flow cell layer 252 can include a second fluidic line 142 fluidically coupled to the inlet opening 146 and to the channel 130 at a plurality of locations such as at the notches 264, 1602 (see, FIGS. 16 and 17) and/or the first flow cell layer 251 can include a second outlet opening 146 (see, for example, FIGS. 10, 12, and 13) and the second flow cell layer 252 can include a second fluidic line 142 fluidically coupled to the second outlet opening 146 and to the channel 130 at a plurality of locations such as at the notches 264. Other arrangements can be suitable to achieve the different arrangements disclosed.

FIG. 13 is a plan view of another flow cell assembly 1300 that can be used to implement the flow cell assembly 103 of FIG. 1. The flow cell assembly 1300 of FIG. 13 is similar to the flow cell assembly 1200 of FIG. 12. However, in contrast, one of the notches 264 extends from the first side 134 of the channel 130 and the other one of the notches 264 extends from the second side 138 of the channel 130. The flow cell manifold assembly 140 does not include the additional fluidic lines 1204 and the manifold port 1210.

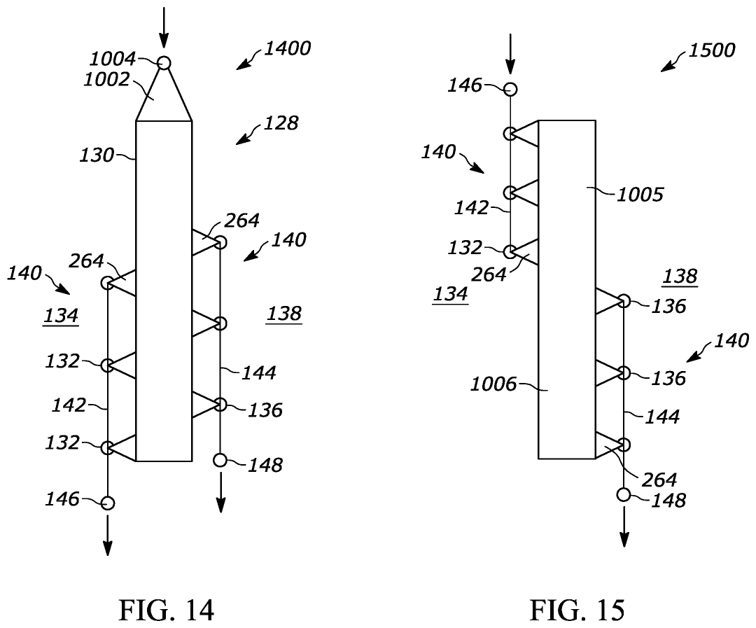

FIG. 14 is a plan view of another flow cell assembly 1400 that can be used to implement the flow cell assembly 103 of FIG. 1. The flow cell assembly 1400 of FIG. 14 is similar to the flow cell assembly 1000 of FIG. 10. However, in contrast, the first openings 132 of the flow cell assembly 1400 of FIG. 14 are asymmetric and/or staggered relative to the second openings 136.

FIG. 15 is a plan view of another flow cell assembly 1500 that can be used to implement the flow cell assembly 103 of FIG. 1. The flow cell assembly 1500 of FIG. 15 is similar to the flow cell assembly 250 of FIG. 2. However, in contrast, the first openings 132 of the flow cell assembly 1500 of FIG. 15 are arranged along the first portion 1005 of the channel 130 and the second openings 136 are arranged along the second portion 1006 of the channel 130. The first manifold fluidic line 142 thus does not overlap the second manifold fluidic line 144.

FIG. 16 is a plan view of another flow cell assembly 1600 that can be used to implement the flow cell assembly 103 of FIG. 1. The flow cell 128 of FIG. 16 includes the first openings 132 positioned on the first side 134 of the channel 130 and includes second openings 136 positioned at the ends 162, 264 of the flow cell 128. The positioning of the first openings 132 and the second openings 136 may encourage approximately half of the fluid to flow out of the second opening 136 on the first side 162 and may encourage approximately half of the fluid to flow out of the second opening 136 on the second side 162, thereby reducing impedance and improving flushing of the channel 130. While the flow cell 128 of FIG. 16 includes two of the first openings 132, the flow cell 128 can include any number of the first openings 132 (e.g., 1, 3, 4, 5).

The flow cell 128 also includes notches 1602 at the ends 162, 164 of the channel 130 that each have first and second sides 1604, 1606 that extend from the walls 1208, 1210 to the corresponding second opening 136. The first side 1604 is longer than the second side 1606 in the implementation shown and thus the notches 1602 are asymmetric and/or form a scalene triangle. The flow cell manifold assembly 140 of FIG. 16 includes additional fluidic lines 1204 that couple the first openings 132 to the single manifold port 1106.

FIG. 17 is a plan view of another flow cell assembly 1700 that can be used to implement the flow cell assembly 103 of FIG. 1. The flow cell assembly 1700 of FIG. 17 is similar to the flow cell assembly 1600 of FIG. 16. However, in contrast, the flow cell assembly 1700 of FIG. 17 includes additional first openings 132 and additional fluidic lines 1204 that couple the first openings 132 to the manifold port 1106.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a system including a flow cell interface; and
a flow cell assembly, comprising:
a flow cell having a channel, the flow cell defining a plurality of first openings fluidically coupled to the channel and arranged on a first side of the channel and a plurality of second openings fluidically coupled to the channel and arranged on a second side of the channel;
a flow cell manifold assembly coupled to the flow cell and having a first manifold fluidic line having a first fluidic line opening and being fluidically coupled to each of the first openings and having a second manifold fluidic line having a second fluidic line opening and being fluidically coupled to each of the second openings; and
one or more gaskets coupled to the flow cell manifold assembly and fluidically coupled to the first fluidic line opening and the second fluidic line opening;
wherein the flow cell interface is engagable with the one or more gaskets to establish a fluidic coupling between the system and the flow cell.

2. The apparatus of claim 1, wherein the first openings and the second openings are asymmetric.

3. The apparatus of claim 1, wherein a gap height of the channel is less than or equal to approximately 50 micrometers or is less than or equal to approximately 25 micrometers.

4. (canceled)

5. The apparatus of claim 1, wherein a gap height of each of the first manifold fluidic line and the second manifold fluidic line is less than or equal to approximately 125 micrometers.

6. (canceled)

7. The apparatus of claim 1, wherein the first openings are evenly spaced from one another and the second openings are evenly spaced from one another.

8. The apparatus of claim 1, wherein at least some of the first openings are staggered relative to at least some of the second openings.

9. (canceled)

10. The apparatus of claim 1, wherein the first manifold fluidic line has a portion that is substantially parallel to a longitudinal axis of the channel and the second manifold fluidic line has a portion that is substantially parallel to the longitudinal axis of the channel.

11. The apparatus of claim 1, wherein the channel has a first end and a second end and wherein the first manifold fluidic line is at least partially adjacent the first end and spaced from the second end and wherein the second manifold fluidic line is at least partially adjacent the second end and spaced from the first end.

12. (canceled)

13. The apparatus of claim 1, wherein the first manifold fluidic line has a variable cross-section.

14. An apparatus, comprising:
a flow cell having a channel, the flow cell defining a plurality of first openings fluidically coupled to the channel and arranged on a first side of the channel and a plurality of second openings fluidically coupled the channel and arranged on a second side of the channel; and
a flow cell manifold assembly coupled to the flow cell and having a first manifold fluidic line having a first fluidic line opening and being fluidically coupled to each of the first openings and having a second manifold fluidic line having a second fluidic line opening and being fluidically coupled to each of the second openings.

15. The apparatus of claim 14, wherein the flow cell comprises a plurality layers that define the channel, the first openings, and the second openings.

16. The apparatus of claim 14, wherein the channel is substantially rectangular.

17. The apparatus of claim 14, wherein the channel has a width of between approximately 4.0 millimeters and approximately 6.0 millimeters and a length of between approximately 55.0 millimeters and approximately 67.0 millimeters.

18. (canceled)

19. (canceled)

20. The apparatus of claim 14, wherein a gap height of the channel is different than a gap height of the first manifold fluidic line.

21-23. (canceled)

24. The apparatus of claim 14, wherein the flow cell manifold assembly comprises a first laminate layer, a second laminate layer, and a third laminate layer and wherein the first laminate layer comprises the first fluidic line opening and the second fluidic line opening, the second laminate layer comprises the first manifold fluidic line and the second manifold fluidic line, and the third laminate layer comprises first ports fluidically coupled to the first manifold fluidic line and the first openings of the flow cell and second ports fluidically coupled to the second manifold fluidic line and the second openings of the flow cell.

25. The apparatus of claim 14, wherein the flow cell manifold assembly comprises a first laminate layer and a second laminate layer, and wherein the first laminate layer comprises the first fluidic line opening and the second fluidic line opening and the second laminate layer comprises a channel that forms the first manifold fluidic line fluidically coupled to the first openings of the flow cell and a channel that forms the second manifold fluidic line fluidically coupled to the second openings of the flow cell.

26. The apparatus of claim 25, wherein the flow cell manifold assembly further comprises a third laminate layer comprises first ports fluidically coupled to the first manifold fluidic line and the first openings of the flow cell and second ports fluidically coupled to the second manifold fluidic line and the second openings of the flow cell, wherein the flow cell manifold assembly further comprises a fourth laminate layer comprising a channel that forms the first manifold fluidic line, wherein the channel of the fourth laminate layer aligns with the channel of the second laminate layer and forms the first manifold fluidic line.

27-32. (canceled)

33. An apparatus, comprising:
a flow cell, comprising:
a channel;
a plurality of first openings fluidically coupled to the channel and arranged on a first side of the channel; and
a plurality of second openings fluidically coupled to the channel and arranged on a second side of the channel.

34. (canceled)

35. The apparatus of claim 33, wherein the flow cell comprises a first flow cell layer, a second flow cell layer, and a third flow cell layer, wherein the first flow cell layer comprises the first openings and the second openings, and the second flow cell layer comprises the channel and is coupled between the first flow cell layer and the third flow cell layer.

36. The apparatus of claim 35, wherein the second flow cell layer comprises a plurality of notches fluidically coupled to the channel and aligned with the first openings and the second openings of the first flow cell layer.

37-69. (canceled)
